(19) United States
(12) Patent Application Publication
(10) Pub. No.: US 2024/0198307 A1
(43) Pub. Date: Jun. 20, 2024

(54) PROCESSES AND APPARATUSES FOR HEATING A HYDROCARBON PROCESS STREAM

(71) Applicant: UOP LLC, Des Plaines, IL (US)

(72) Inventors: Chintan Surendra Shah, Haryana (IN); Phillip F. Daly, Palatine, IL (US); Pankaj Kumar Singh, New Delhi (IN); Soumendra Mohan Banerjee, New Delhi (IN)

(21) Appl. No.: 18/456,049

(22) Filed: Aug. 25, 2023

Related U.S. Application Data
(60) Provisional application No. 63/387,404, filed on Dec. 14, 2022.

(51) Int. Cl. B01J 8/04

(52) U.S. Cl. CPC B01J 8/0496; B01J 8/0492; B01J 2208/00398; B01J 2208/00407; B01J 2208/00415; B01J 2208/00504

(57) ABSTRACT

Processes and apparatuses for heating a hydrocarbon process stream, with an electrical heater to provide a portion of the heat requirement necessary for a chemical reaction to occur to one of the components of the hydrocarbon process stream. The electric heater may be in series or in parallel with a second, or main heater. The electric heater may be used between two reaction zones or between a feed exchange heater and a first reaction zone. The electric heater preferably provides between 5 to 40% of the heating requirement for the process stream.

### RELATED APPLICATIONS

This application claims priority to U.S. Provisional Patent Application Ser. No. 63/387,404 filed on Dec. 14, 2022, the entirety of which is incorporated herein by reference.

### FIELD OF THE INVENTION

This invention relates generally to processes and apparatuses for heating a hydrocarbon process stream, and more particularly to processes and apparatuses that use an electrical heater to provide a portion of the heat requirement to the hydrocarbon process stream.

### BACKGROUND OF THE INVENTION

The world is moving towards greener and cleaner technology offerings. In view of the Paris Agreement most countries have a target of becoming carbon neutral by either 2030 or 2050.

In light of the same, there is increased focus on reducing fossil fuel consumption, improving efficiencies to reduce carbon dioxide footprint, and increasing dependency on renewable sources of energy. With the pivoting of the refining and petrochemical industries towards sustainable sources of energy like solar, wind, hydroelectric, nuclear, etc. and the making of more green electricity available, there is the desire to reduce the size of fired heaters for technologies like hydrocarbon reforming, dehydrogenation, isomerization, transalkylation, hydrotreating, and others.

Accordingly, it would be desirable to have more effective and efficient ways to heat process streams to the desired or required temperature that reduce reliance on carbon dioxide producing heating devices and processes.

### SUMMARY OF THE INVENTION

The present invention addresses these problems by providing processes and apparatuses in which electric inline heating and heaters are utilized in conjunction with the main or primary heaters in various hydrocarbon processing zones and devices. In addition to reducing the carbon dioxide produced with such heaters, the present invention allows for smaller fired heaters to be used and thereby reducing plot space for similar capacity process units.

The integration of inline electric heating can also help in reducing process outlet temperatures from fired heaters, which in turn will result in lower tube wall temperatures and lower peak film temperatures. This can help mitigate issues like metal-catalyzed coking (MCC) and thermal (non-selective) cracking, which are reduced at lower heater outlet temperatures in various reforming technologies.

Electric heating also delivers excellent turndown capabilities, providing operating and process flexibility to run at low heat duties that cannot readily be achieved by fired heaters, or that cannot be achieved by fired heaters while maintaining efficient or clean burning of the fuel gas.

This flexibility can be useful for precise process control, turndown operation, and for start-up operations, especially for startups where controlled heat up rates of the reactor loop equipment is important. For example, the electric heater could eliminate the need for burners and additional controls designed for low-flow low-firing operation needed at start-up.

Additionally, many reformers are seeking unit capacity increases (BPSD wise) for technologies like reforming, and there is a need for additional heater cells (helper/auxiliary heaters), which are placed either in series or in parallel, and thus increase the plot space requirement as well as pose challenges to transfer pipe layout with respect to the reactor location. The integration of electric heaters in the transfer lines (to achieve inline heating) will utilize the transfer lines (already in the plot plan) and will reduce the need or size of helper/auxiliary heaters, thus reducing need of plot space, and mitigating the challenges of transfer line thermal expansion and stress issues with respect to reactor.

The process fluid temperature at the fired heater outlet will be lower and the final piece of heating may happen in the “inline electric heater.” Therefore, the solutions in the present invention will not only reduce hot volumes, but it will also reduce the thermal expansion temperature impact of the fired heater on the transfer line, and thus provide some mitigation of line stresses.

Plot space constraints and capacity increase challenges with respect to revamped processing units can be addressed with the inline electric heating by integrating them with the existing fired heater. For some revamps of existing reforming units, the steam system equipment can be limiting (like steam drum, BFW circulation pump etc.). By providing the additional heat duty for a revamp with the inline electric heater, the steam system equipment on the existing fired heaters will not need to be changed.

In addition to providing electric heaters in the transfer lines, the present invention also contemplates providing electric heating elements inside of the reactor, providing the same benefits as described above, while potentially further reducing the hot volume.

While this design is applicable to both new and revamp designs, the invention is believed to be particularly beneficial as part of retrofit solution to achieve carbon dioxide reduction.

It is thought that integration of “inline electric heating” with hydrocarbon reforming and similar technologies, can result in at least a 10-20% reduction in the size of each fired heater service (both charge and inter reactor heaters). Additionally, the lower heater outlet temperatures (approximately 5.6 to 11.1° C. (10 to 20° F.) lower or more) will lead to further optimization of heat flux and thus facilitate reduction of fired heater sizes.

Therefore, the present invention may be characterized, in at least one aspect, as providing a chemical reaction process zone having: at least one reaction zone having a reactor which receives a feed stream and which, under suitable conditions, results in a chemical reaction of a component of the feed stream; and, a heating zone configured to provide heat to the feed stream upstream of the at least one reaction zone. The heating zone includes: an electric heater configured to provide a first portion of a heating requirement to the feed stream; and, a second heater configured to provide a second portion of the heating requirement to the feed stream, wherein the first portion and the second portion achieve a minimum temperature, and wherein the second heater is either a fired heater or an electric heater.

The at least one reaction zone may include two reactors, and the electric heater may be disposed in a transfer line between the first reactor and the second reactor.

The electric heater may be disposed in a transfer line upstream of the second heater.

The electric heater may be disposed in a transfer line downstream of the second heater.

The electric heater may be disposed inside a reactor having a catalyst bed, before the catalyst bed.

The electric heater may be disposed inside a reactor having a catalyst bed, after the catalyst bed.

The electric heater may be disposed inside a reactor having multiple catalyst beds, and the electric heater may be located after the catalyst bed and before a second catalyst bed.

The first portion of the heating requirement may be between 5% to 40% of the heating requirement.

The electric heater may be installed at an elbow location in a transfer line and wherein the feed stream may flow parallel to the electric heater in the transfer line.

The electric heater may be installed in a transfer line and the feed stream may flow perpendicularly to the electric heater.

The electric heater may be disposed is installed in a transfer line in an arrangement configured to cover an entire cross section of the transfer line.

The second heater may be a fired heater and the electric heater may be arranged in series with the fired heater.

The second heater may be a fired heater and the electric heater may be arranged in parallel with the fired heater.

The chemical reaction process zone may further include a second electric heater arranged in series with the fired heater.

In a second aspect, the present invention may be generally characterized process for a chemical reaction by: heating a process stream in an electric heater; heating the process stream in a second heater, wherein the second heater is either a fired heater or an electric heater; passing the process stream to a reactor, in a reaction zone, which, under suitable conditions, results a chemical reaction of a component of the feed stream; and, recovering an effluent stream from the reactor.

The electric heater may be upstream of the second heater.

The electric heater may be downstream of the second heater.

The second heater may be a fired heater and the electric heater may be arranged in series with the fired heater.

The second heater may be a fired heater and wherein the electric heater may be arranged in parallel with the fired heater.

The process may further include a second electric heater arranged in series with the fired heater.

The electric heater may provide between 5% to 40% of a heating requirement for the chemical reaction.

The process stream may be an effluent from an upstream reactor in the reaction zone.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

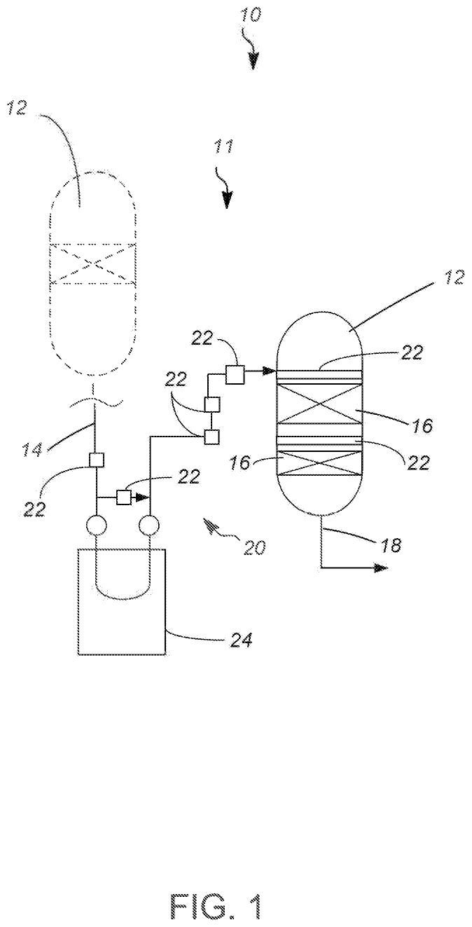

FIG. 1 depicts a process flow diagram according to one or more aspects of the present invention;

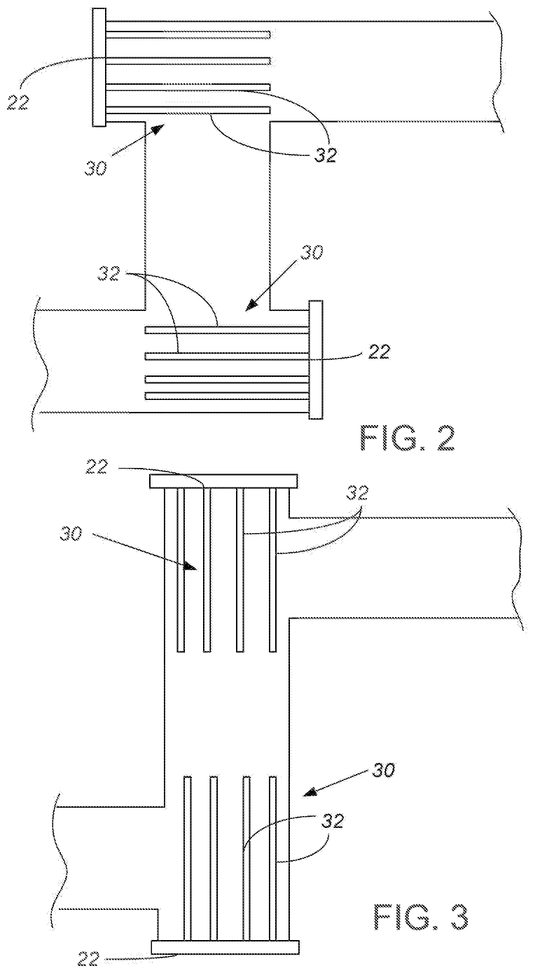

FIG. 2 depicts a side cutaway schematic of inline heaters according to one or more aspects of the present invention;

FIG. 3 depicts another side cutaway schematic of inline heaters according to one or more aspects of the present invention;

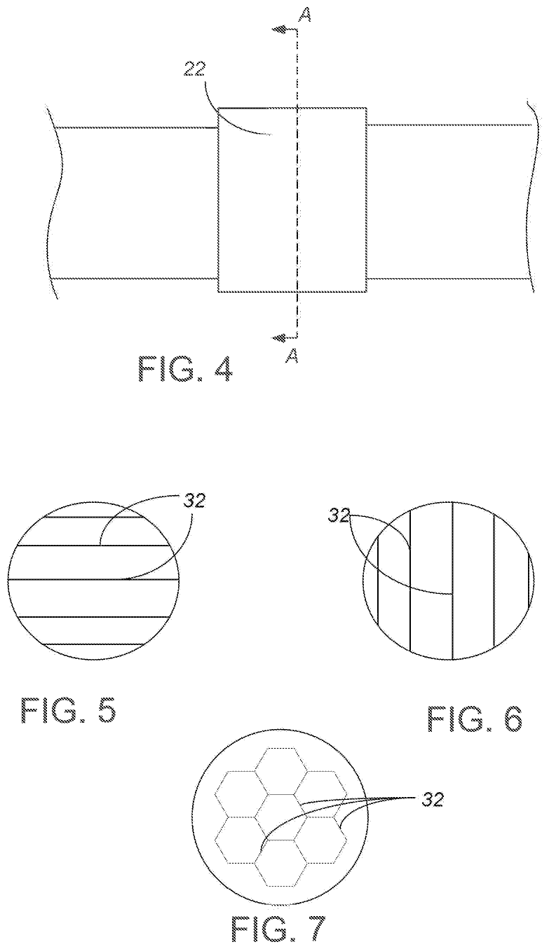

FIG. 4 depicts a side schematic of inline heaters according to one or more aspects of the present invention;

FIG. 5 depicts a cross section view taken along line A-A in FIG. 4 according to one or more aspects of the present invention;

FIG. 6 depicts a cross section view taken along line A-A in FIG. 4 according to one or more aspects of the present invention; and,

FIG. 7 depicts a cross section view taken along line A-A in FIG. 4 according to one or more aspects of the present invention.

### DETAILED DESCRIPTION OF THE INVENTION

As mentioned above, the present invention proposes inline electrical heating to be utilized with other, primary, heaters. The use of the electrical heaters addresses multiple issues and provides higher fuel efficiency of the fired heaters, reduced carbon dioxide footprint, lower hot volumes, higher yields, lower plot space for fired heaters, and lower stress values for transfer lines.

With these general principles in mind, one or more embodiments of the present invention will be described with the understanding that the following description is not intended to be limiting.

As shown in FIG. 1, a chemical reaction zone 10 includes at least one reaction zone 11 having a reactor 12 which receives a feed stream 14. Inside of the reactor 12 may be a catalyst bed 16 which, under suitable conditions, catalyzes a chemical reaction of a component of the feed stream 14 and so that the reactor 12 produces at least one effluent stream 18. Alternatively, the reactor 12 may not include a catalyst bed and the chemical reaction zone may proceed without a catalyst. The feed stream 14 may be an effluent, or partial effluent from another reactor 12 in the reaction zone 11.

In order for the desired chemical reactions to take place, the feed stream 14 must be heated to a desired or required temperature. In other words, there is a heating requirement for the feed stream 14. Therefore, in order to provide heat to the feed stream 14 upstream of the reaction zone 11, the chemical reaction zone 10 also includes a heating zone 20.

The heating zone 20 includes one or more electric heaters 22 and a second heater 24. The electric heaters 22 are configured to provide a first portion of a heating requirement for the feed stream 14. The second heater 24 is configured to provide a second portion of the heating requirement for the feed stream 14. The first portion and the second portion together achieve a minimum temperature. The second heater 24 is either a fired heater or an electric heater. Preferably, the electric heaters 22 together provide between 5 to 40%, or more, or between 5 to 20%, or more, of the heating requirement for the feed stream 14.

As noted above, the heating zone 20, and more specifically, the electric heater 22 may be disposed between two reactors 12. The electric heater 22 may be located at the inlet of the second heater 24 or at the outlet of the second heater 24, or at both. The electric heater 22 may be in series and/or in parallel with the second heater 24. The electric heater 22 may be disposed in the reactor 12, before the catalyst bed 16, so that the feed stream passes through the electric heater 22 before passing through the catalyst bed 16. The electric heater 22 may also be located after the catalyst bed 16 or between catalyst beds 16.

Turning to FIGS. 2 and 3, electric heaters 22 having a heater bundle 30 with hairpin shaped heating tubes or elements 32 are shown. It should be appreciated that multiple bundles 30 may be used. The hairpin shaped heating tubes 32 may be up to 10 feet in length, with typical outside diameters of 0.43″. A single electric heater bundle 30, with a bundle diameter of 50″ and an immersed length of 7′ (heated length of 5′) can provide approximately 1.8 MW of heat to the process (5.6° C. (10° F.) of temperature increase for 633,000 lb/hr of reactor vapor flow), with a pressure drop of 3.4 kPa (0.5 psi). Different bundle 30 diameters and lengths are possible to optimize the performance and meet process requirements.

The electric heater bundle 30 can be installed with parallel flow over the hairpin shaped heating tubes 32 (FIG. 2) which provides the most uniform flow over all the elements, eliminating flow maldistribution and corresponding hot regions in the bundle 30. An elbow in the typical transfer lines can be replaced with a T, and the electric heater bundle 30 can then be installed into the piping through the long portion of the T. While FIG. 2 shows that the orientation of the electric heater bundle and the flow can be horizontal, FIG. 3 shows that the orientation of the bundle and the flow may also be vertical. FIG. 2 and FIG. 3 also show that the inlet (or outlet) of the flow may be arranged with either end of the electric heater bundle, allowing the design of the bundle to be optimized with respect to the temperatures of the flow.

It is also contemplated that the electric heater 22 is not disposed at an elbow, but in the middle of transfer line. For example, as shown in FIG. 4, the hairpin shaped heating tubes can be installed with crossflow across the bundle of the electric heater 22. This will limit the length of the tubes and/or bundle of the electric heater 22 based on the diameter of the transfer line, as the tubes and/or bundle of the electric heater 22 will be perpendicular to the flow in the line (left to right or right to left in FIG. 4).

Thus, the heating elements 32 can be parallel to each other with a horizontal orientation (FIG. 5) or a vertical orientation (FIG. 6) or with an orientation somewhere in between. It is additionally contemplated that a combination of orientations is provided, for example a combination of vertical and horizontal orientations that provide a mesh-like pattern. Additionally, it is further contemplated that the heating elements 32 have a geometric shape FIG. 7 (such as hexagons or spiral coils).

Proper baffles or shrouds around the heating bundle are contemplated to maximize the velocity over the bundle and eliminate maldistribution and hot regions of the bundle. Multiple bundles can be installed to achieve the desired heat duty.

Installing longer electric heater bundles and multiple bundles can be used to reduce the element temperatures, to better eliminate fouling and coking and to improve design life. The design of the electric heaters must carefully consider the fluid temperatures, element temperatures, heat duty, pressure drops, and the fouling/coking tendencies of the process fluid.

The electric heater bundles may be installed directly upstream or directly downstream of a fired heater, or both (this applies to a charge heater and/or an interstage heater). The electric heater provides the greatest advantage to the fired heater when downstream, as it reduces the outlet temperature of the fired heater which can be used for optimization of the fired heater design and size savings. Additionally, the electric heater bundles may be installed proximate the reactor inlet to minimize hot volumes.

The heat duty of the electric heater 22 can be controlled and monitored by, for example, flow temperature measurements and element temperature measurements. In addition to ensuring appropriate heating, such data may be used to protect the elements from over-heating and failing. Thus, set levels may be utilized to control heat duty to avoid overheating. Reduced heat from electric heaters could be compensated for with the fired heaters.

Additionally, heat duty control may be of multiple bundles, individual bundles, or of multiple groups of elements within a single bundle. This would be selected to optimize the performance and reliability of the electric heater operation.

The electric heater may be installed upstream of the fired heater, based on layout needs and availability, or to improve the electric heater design. The upstream location helps minimize the temperatures of the elements, to better eliminate fouling and coking and to improve design life. The electric heater hairpin elements can also be arranged around the inlet or outlet of a radial flow reactor. This arrangement eliminates the need for space in the transfer lines, and it can further reduce the hot residence time.

### EXPERIMENTS

A quick yield estimate was simulated in a reforming reactor for in which 50% of the hot volume from all transfer lines, heater manifold, and heater tubes operated at 20 deg F. lower than a conventional design while keeping all the other parameters (i.e., reactor inlet temperatures, pressure etc.) remained the same. In addition to showing the reduction of carbon dioxide production, the simulation estimated a 0.2 wt % additional C5+ yield over the current design.

A quick thermal rating of fired heater in reforming process unit was performed wherein the heater terminal temperatures were reduced by 11° C. (20° F.) to quantify/estimate the heater performance, it was noted that such reduced heater terminal temperatures lead to 20% reduction in fuel consumption as well as similar 20% reduction of carbon dioxide production.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### SPECIFIC EMBODIMENTS

While the following is described in conjunction with specific embodiments, it will be understood that this description is intended to illustrate and not limit the scope of the preceding description and the appended claims.

A first embodiment of the invention is a chemical reaction process zone comprising at least one reaction zone having a reactor which receives a feed stream and which, under suitable conditions, results in a chemical reaction of a component of the feed stream; and, a heating zone configured to provide heat to the feed stream upstream of the at least one reaction zone, wherein the heating zone comprises an electric heater configured to provide a first portion of a heating requirement to the feed stream; and, a second heater configured to provide a second portion of the heating requirement to the feed stream, wherein the first portion and the second portion achieve a minimum temperature, and wherein the second heater is either a fired heater or an electric heater. An embodiment of the invention is one, any or all of prior embodiments in this paragraph up through the first embodiment in this paragraph, wherein the at least one reaction zone comprises two reactors, and wherein the electric heater is disposed in a transfer line between the first reactor and the second reactor. An embodiment of the invention is one, any or all of prior embodiments in this paragraph up through the first embodiment in this paragraph, wherein the electric heater is disposed in a transfer line upstream of the second heater. An embodiment of the invention is one, any or all of prior embodiments in this paragraph up through the first embodiment in this paragraph, wherein the electric heater is disposed in a transfer line downstream of the second heater. An embodiment of the invention is one, any or all of prior embodiments in this paragraph up through the first embodiment in this paragraph, wherein reactor comprises a catalyst bed and wherein the electric heater is disposed inside the reactor, before the catalyst bed. An embodiment of the invention is one, any or all of prior embodiments in this paragraph up through the first embodiment in this paragraph, wherein reactor comprises a catalyst bed and wherein the electric heater is disposed inside the reactor, after the catalyst bed. An embodiment of the invention is one, any or all of prior embodiments in this paragraph up through the first embodiment in this paragraph, wherein reactor comprises a first catalyst bed and a second catalyst bed, and wherein the electric heater is disposed inside the reactor, and wherein the electric heater is located after the first catalyst bed and before a second catalyst bed. An embodiment of the invention is one, any or all of prior embodiments in this paragraph up through the first embodiment in this paragraph, wherein the first portion of the heating requirement is between 5%-40% of the heating requirement. An embodiment of the invention is one, any or all of prior embodiments in this paragraph up through the first embodiment in this paragraph, wherein the electric heater is installed at an elbow location in a transfer line and wherein the feed stream flows parallel to the electric heater. An embodiment of the invention is one, any or all of prior embodiments in this paragraph up through the first embodiment in this paragraph, wherein the electric heater is installed in a transfer line and the feed stream flows perpendicular to the electric heater. An embodiment of the invention is one, any or all of prior embodiments in this paragraph up through the first embodiment in this paragraph, wherein the electric heater is disposed is installed in a transfer line in an arrangement configured to cover an entire cross section of the transfer line. An embodiment of the invention is one, any or all of prior embodiments in this paragraph up through the first embodiment in this paragraph, wherein the second heater is a fired heater and wherein the electric heater is arranged in series with the fired heater. An embodiment of the invention is one, any or all of prior embodiments in this paragraph up through the first embodiment in this paragraph, wherein the second heater is a fired heater and wherein the electric heater is arranged in parallel with the fired heater. An embodiment of the invention is one, any or all of prior embodiments in this paragraph up through the first embodiment in this paragraph, further comprising a second electric heater arranged in series with the fired heater.

A second embodiment of the invention is a process for a chemical reaction, the process comprising heating a process stream in an electric heater; heating the process stream in a second heater, wherein the second heater is either a fired heater or an electric heater; passing the process stream to a reactor, in a reaction zone, which, under suitable conditions, produces a chemical reaction of a component of the feed stream; and, recovering an effluent stream from the reactor. An embodiment of the invention is one, any or all of prior embodiments in this paragraph up through the second embodiment in this paragraph, wherein the electric heater is upstream of the second heater. An embodiment of the invention is one, any or all of prior embodiments in this paragraph up through the second embodiment in this paragraph, wherein the electric heater is downstream of the second heater. An embodiment of the invention is one, any or all of prior embodiments in this paragraph up through the second embodiment in this paragraph, wherein the second heater is a fired heater and wherein the electric heater is arranged in series with the fired heater. An embodiment of the invention is one, any or all of prior embodiments in this paragraph up through the second embodiment in this paragraph, wherein the second heater is a fired heater and wherein the electric heater is arranged in parallel with the fired heater. An embodiment of the invention is one, any or all of prior embodiments in this paragraph up through the second embodiment in this paragraph, further comprising a second electric heater arranged in series with the fired heater. An embodiment of the invention is one, any or all of prior embodiments in this paragraph up through the second embodiment in this paragraph, wherein the electric heater provides between 5%-40% of a heating requirement for the chemical reaction. An embodiment of the invention is one, any or all of prior embodiments in this paragraph up through the second embodiment in this paragraph, wherein the process stream comprises an effluent from an upstream reactor in the reaction zone.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, unless otherwise indicated, all parts and percentages are of “a heating requirement”, which would be of a heat flow (e.g. Watts, Btu/hr).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A chemical reaction process zone comprising:
at least one reaction zone having a reactor which receives a feed stream and which, under suitable conditions, results in a chemical reaction of a component of the feed stream; and,
a heating zone configured to provide heat to the feed stream upstream of the at least one reaction zone, wherein the heating zone comprises:
an electric heater configured to provide a first portion of a heating requirement to the feed stream; and,
a second heater configured to provide a second portion of the heating requirement to the feed stream, wherein the first portion and the second portion achieve a minimum temperature, and wherein the second heater is either a fired heater or an electric heater.

2. The chemical reaction process zone of claim 1, wherein the at least one reaction zone comprises two reactors, and wherein the electric heater is disposed in a transfer line between the first reactor and the second reactor.

3. The chemical reaction process zone of claim 1, wherein the electric heater is disposed in a transfer line upstream of the second heater.

4. The chemical reaction process zone of claim 1, wherein the electric heater is disposed in a transfer line downstream of the second heater.

5. The chemical reaction process zone of claim 1, wherein reactor comprises a catalyst bed and wherein the electric heater is disposed inside the reactor, before the catalyst bed.

6. The chemical reaction process zone of claim 1, wherein reactor comprises a catalyst bed and wherein the electric heater is disposed inside the reactor, after the catalyst bed.

7. The chemical reaction process zone of claim 1, wherein reactor comprises a first catalyst bed and a second catalyst bed, and wherein the electric heater is disposed inside the reactor, and wherein the electric heater is located after the first catalyst bed and before a second catalyst bed.

8. The chemical reaction process zone of claim 1, wherein the first portion of the heating requirement is between 5%-40% of the heating requirement.

9. The chemical reaction process zone of claim 1, wherein the electric heater is installed at an elbow location in a transfer line and wherein the feed stream flows parallel to the electric heater.

10. The chemical reaction process zone of claim 1, wherein the electric heater is installed in a transfer line and the feed stream flows perpendicular to the electric heater.

11. The chemical reaction process zone of claim 1, wherein the electric heater is disposed is installed in a transfer line in an arrangement configured to cover an entire cross section of the transfer line.

12. The chemical reaction process zone of claim 1, wherein the second heater is a fired heater and wherein the electric heater is arranged in series with the fired heater.

13. The chemical reaction process zone of claim 1, wherein the second heater is a fired heater and wherein the electric heater is arranged in parallel with the fired heater.

14. The chemical reaction process zone of claim 13, further comprising:
a second electric heater arranged in series with the fired heater.

15. A process for a chemical reaction, the process comprising:
heating a process stream in an electric heater;
heating the process stream in a second heater, wherein the second heater is either a fired heater or an electric heater;
passing the process stream to a reactor, in a reaction zone, which, under suitable conditions, produces a chemical reaction of a component of the feed stream; and,
recovering an effluent stream from the reactor.

16. The process of claim 15, wherein the electric heater is upstream of the second heater or the electric heater is downstream of the second heater.

17. The process of claim 15, wherein the second heater is a fired heater and the electric heater is arranged in series with the fired heater, or
wherein the second heater is a fired heater and the electric heater is arranged in parallel with the fired heater.

18. The process of claim 17, further comprising:
a second electric heater arranged in series with the fired heater.

19. The process of claim 15, wherein the electric heater provides between 5%-40% of a heating requirement for the chemical reaction.

20. The process of claim 15, wherein the process stream comprises an effluent from an upstream reactor in the reaction zone.
